(19) United States
(12) Patent Application Publication
(10) Pub. No.: US 2006/0089899 A1
(43) Pub. Date: Apr. 27, 2006

(54) Intra-day matching message system and method

(76) Inventors: Bryan T. Durkin, Orland Park, IL (US); Thomas G. McCabe, Chicago, IL (US); James G. Bennett, Glen Ellyn, IL (US); Dennis M. Collins, Downers Grove, IL (US); Melissa H. Kemp, Barrington Lake, IL (US); Anita Olivia Lynch, Chicago, IL (US); Jacqueline B. Owens, South Holland, IL (US); Laurence M. Ratner, Deerfield, IL (US); Mary Beth E. Rooney, Park Ridge, IL (US)

Correspondence Address: MCCRACKEN & FRANK LLP, 200 W. ADAMS STREET, SUITE 2150, CHICAGO, IL, 60606, US

(21) Appl. No.: 11/237,015

(22) Filed: Sep. 28, 2005

Related U.S. Application Data
(60) Provisional application No. 60/621,781, filed on Oct. 25, 2004.
(60) Provisional application No. 60/622,890, filed on Oct. 28, 2004.

(51) Int. Cl. G06Q 40/00

(52) U.S. Cl. 705/37

(57) ABSTRACT

A system and method that provides a message engine to facilitate intra-day receiving of first data relative to the trade transaction on behalf of one party to the trade transaction, wherein the first data include a code identifying an opposing party to the transaction; sending a message to the designated opposing party prior to submitting the trade transaction for matching prior to end-of-day clearing; and monitoring a message queue for a response and sending a message to at least one of the parties based on the response.

### CROSS REFERENCE TO RELATED APPLICATIONS

This application claims the benefit of U.S. Provisional Application No. 60/621,781 filed Oct. 25, 2004, entitled “Trade Confirmation System,” and the benefit of U.S. Provisional Application No. 60/622,890 filed Oct. 28, 2004, entitled “Trade Confirmation System.”

### REFERENCE REGARDING FEDERALLY SPONSORED RESEARCH OR DEVELOPMENT

Not applicable

### SEQUENTIAL LISTING

Not applicable

### BACKGROUND OF THE INVENTION

1. Field of the Invention

This invention relates to a message system to facilitate the confirmation of trade transactions made in an open outcry or similar market in near real time. More particularly, this invention relates to a communication system that coordinates with an intra-day matching system to minimize unmatched incorrectly entered trade transactions.

2. Description of the Background of the Invention

In a typical exchange setting, traders will make trade transactions for a wide variety of tradable products using face-to-face communication techniques. A trade transaction can involve stocks, bonds, financial instruments, futures, options, cash, and other similar instruments. The concept of a financial instrument in today's marketplace can include a wide variety of items that have extended far beyond what was originally considered a financial instrument. This includes contracts for the future delivery of agricultural and other commodities, including metals, oils, and the like. Also, the financial instrument can include derivative instruments that include options of all types and instruments that are based on a basket of other instruments, such as options based on the Dow Jones Industrial Average, currency exchange baskets, and the like. A trade transaction can include the buying and selling of any of the above financial instruments and similar instruments, as well as similar rights and obligations.

In an open outcry pit, trading involves the use of hand signals where two traders each indicate their willingness to make a trade transaction at a particular price point. Currently, these trade transactions are recorded on paper slips that are then passed to a runner or clerk for entry into the computer system of the trader, broker, and/or clearing firm. The data from the trader's system are then passed on to the computer system of the exchange for clearing. With both sides making manual entries, both on the paper slip and into their respective computer systems, there is an opportunity to have one side of the trade transaction entered incorrectly.

Exchanges have procedures at the close of a trading day to reconcile these incorrectly entered trade transactions and most errors are corrected. However, this procedure can be time consuming and generally a trader will not know until after the exchange has closed for the day if all the trade transactions the trader thought were made that day were in fact successfully made and entered into the system for clearing. The existing computer systems do not provide real time or even reasonably contemporaneous feedback directly to the traders about the matching or acceptance of trade transaction data that have been entered into these prior systems. As a result, a trader can later discover that a trade transaction the trader thought was successfully concluded was not matched and as a result the trader has exposure the trader did not expect. By the time the error is caught, there is often no way to correct the error that would place traders on both sides of the trade in the position where they thought they were when the trade transaction was actually made. These unmatched trade transactions are known as “out trades” and can be quite costly for the traders involved. The resolution of out trades also causes disruption to the orderly process of running an exchange.

In addition, many trade transactions made today are a part of a strategy of trade transactions designed to minimize risk to the trader by hedging the trade transaction in some fashion against a second and/or third instrument, such that if a single part of the trade strategy is not successfully made due to a data entry or similar clerical error, the trader will often be exposed to considerable risk, many times without knowing that the trader has any exposure.

The use of computers located on or near the trading floor to enter the trade transactions quickly has reduced the number of out trades that are the result of keying errors or errors in transcribing the paper trading slips. These current systems do not provide feedback to the trader or broker relative to the acceptance of the trade transaction data that have been entered. A broker or trader still will not know until the end-of-session or end-of-day processing if all trade transactions that the trader thought were made using these computer systems were in fact correctly entered and matched for clearing.

Electronic trading exchanges that are in use by some exchanges do match trade transactions automatically in real time. The matching of trade transactions in an electronic trading host is done based on a match of the price and quantity or by other similar matching algorithms. These electronic trade matching hosts do not match based on the identity of one or both participants in the trade transaction and in fact most of the electronic trade matching is done anonymously.

If an exchange is able to send trade transactions in matched and locked pairs to the clearing center, the cost to the exchange for processing the trade transactions made that day will be reduced. This is because the clearing center will only need to record a previously fully matched trade transaction. There will be no need to process these trade transactions through the clearing centers' matching algorithms thereby saving time and computing power. In addition, the exchange, and possibly others, will be able to have access to the intra-day matched trade transactions to monitor activity levels, to look for risk management concerns, and to audit activity for abuse of exchange rules and procedures. Furthermore, the use of such a system will enable traders to meet performance standards, such as the entry of a significant percentage of all trade transactions within a predefined time period after the trade transaction has been made. Also, an intra-day matching and communication system will allow a trader to directly monitor the trader's activity throughout the day and have some understanding of the risk of the trader's current position in the market, including the number of trade transactions that have been made but are as yet unmatched.

### SUMMARY OF THE INVENTION

In one embodiment of the present invention a message service facilitates the early confirmation of a trade transaction in a non-anonymous trading environment. The message service has a message reception circuit that receives a message from one party to the trade transaction, the message including trade transaction data that includes an identity of an opposing party to the trade transaction. The message service also has an outgoing message circuit that sends a message to the opposing party that includes data identifying the trade transaction, and a monitoring circuit that monitors a message queue for a message from the opposing party. If an acceptance message is received from the opposing party, the message service sends a confirming message to the one party and sends the trade transaction to a matching engine as a pre-matched trade. If no response is received from the opposing party within a predetermined period of time, the message service sends an alert message to the one party and sends the trade transaction to the matching engine as an unmatched trade. If a rejection message is received from the opposing party, the message service sends an alert message to the one party.

Another embodiment of the present invention is a method of facilitating the early confirmation of a trade transaction in a non-anonymous trading environment. The method comprises the steps of receiving a message from one party to the trade transaction, the message including data relating to the trade transaction including an identity of an opposing party to the trade transaction, and sending a message to the opposing party that includes data identifying the trade transaction. In addition the method includes the step of monitoring a message queue for a message from the opposing party, and a) if an acceptance message is received from the opposing party, sending a confirming message to the one party and sending the trade transaction to clearing as a pre-matched trade; b) if no response is received from the opposing party within a predetermined period of time, sending an alert message to the one party and sending the trade transaction to clearing as an unmatched trade; or c) if a rejection message is received from the opposing party, sending an alert message to the one party.

Other aspects and advantages of the present invention will become apparent upon consideration of the following detailed description.

### BRIEF DESCRIPTION OF THE DRAWINGS

FIG. 1 is an overview flow diagram of one embodiment of the system of the present invention that shows the relation of the message system to other systems such as a clearing system and a matching system;

FIG. 2 is a flow diagram of an additional embodiment of the present invention;

FIG. 3 is a table showing a state of a trade transaction at various times during an embodiment of the present invention;

FIG. 4 is a flow diagram of a further embodiment of the present invention;

FIG. 5 is a flow diagram of an example of another embodiment of the present invention;

FIG. 6 is a flow diagram of an example of a further embodiment of the present invention;

FIG. 7 is a flow diagram of a still further embodiment of the present invention;

FIG. 8 is a flow diagram of yet another embodiment of the present invention;

FIG. 9 is a flow diagram of still another embodiment of the present invention; and

FIG. 10 is a flow diagram that illustrates an aspect of one embodiment of the present invention.

### DETAILED DESCRIPTION OF THE PREFERRED EMBODIMENTS

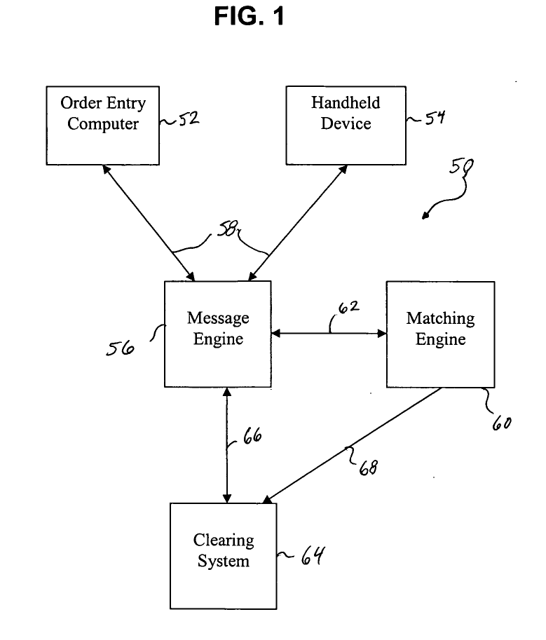

FIG. 1 shows an overview of the architecture of one embodiment of a trading system 50 useful with the present invention. The trading system 50 is a non-anonymous, that is, face-to-face, trading environment such as an open outcry pit that includes a number of electronic input devices. These electronic input devices include, as examples, an order/trade entry computer 52, and a handheld device 54. The order/trade entry computer 52 can be any type of computer typically used in an exchange environment, including computers located near the trading floor or pit, custom programmed computers using an API provided by the exchange or computers running software used by the exchange to record and enter orders into the exchange's computer order system. There can be different input devices of the same class of input devices as well as input devices from different classes connected to the trading system 50 at the same time. The trading system includes a message engine 56 that acts to coordinate and route messages between the various input devices and other elements of the trading system 50. The messages between the message engine 56 and the input devices 52 and 54 pass over a two way interface 58. The interface 58 can be any conventional interconnection between elements of a system, such as Ethernet, the Internet, intranet, wide area network (WAN), wireless connection, or other similar connection. The interface 58 may optionally include a dedicated server to facilitate communication to and from a particular class of input devices, such as a server to facilitate the use of the handheld device 54.

In one embodiment, the communication among the elements will be over a networking and messaging solution known as WebSphere MQ from IBM. The message engine 56 can be any conventional computer that will accommodate a large number of messages and data input streams. One such solution for the message engine 56 is a J2EE Java based system deployed on a BEA WebLogic server. A number of queues can be set up such as one for inbound messages and one to communicate outbound messages. A matching engine 60 will use similar technology. The message and data format will conform to the MQ API and data will be in a language format, such as TREX, FIXML or other similar data formats and structures. These data formats are designed to facilitate intercommunication among exchanges, and their users, such as brokerage firms.

In some exchange scenarios, the order/trade entry computer 52 will be a computer that is located immediately adjacent to a trading pit or floor. The order/trade entry computer 52 may be directly connected to the network that runs order entry software for the exchange or as noted above can be routed through an intermediary server or other connection. Traders or brokers can enter trade transaction data directly into the order/trade entry computer 52 instead of writing the information on a trading slip and handing the slip to a clerk or runner for later data entry. Most exchanges also will have some form of the customized order/trade entry computer 52. These customized order/trade entry computers 52 can be computers running programs developed by the exchange or developed by members of the exchange using an API made available by the exchange. The order/trade entry computers 52 are the traditional method for entry of trade transaction data into the exchange system and may include proprietary systems used by the member firm's back office personnel to enter the trade transaction data from the paper trading slips. Alternatively, order/trade entry computer 52 can be used by the traders themselves through browser based or other computer terminals located near the trading floor if the traders do not have access to the their own order/trade entry computer 52 or the handheld device 54.

In addition, some exchanges now also utilize the handheld device 54 that enables traders to quickly enter the basic details of a trade transaction without leaving the trading floor or pit. The handheld device 54 is programmed to enable traders to enter key information about a trade transaction, such as the nature of the financial instrument traded, i.e., September 2005 corn, the type of trade transaction, i.e., buy or sell, the price, the quantity, and an identifier of the other party to the trade transaction, often by acronym or other identifier. This key information can be quickly entered using shortcuts built into some of the handheld devices 54. The handheld device 54 may be wireless and, if so, communicates with the exchange network through a conventional wireless link.

The message engine 56 is in communication with the matching engine 60 located within the exchange through an interface 62. In one embodiment, the message engine 56, and the matching engine 60 may be separate modules running within the same computer. In this case, the interface 62 is internal to the computer. For embodiments where the message engine 56, and the matching engine 60 are in different computers, the interface 62 also provides two way communications between the message engine 56 and the matching engine 60. Interface 62 typically will be a high speed WAN type or similar connection capable of high amounts of data throughput and that permits high speed two way messaging between the message engine 56 and the matching engine 60. The message engine 56 also is in communication with a clearing system 64 though an interface 66. This interface 66 is a conventional communication system well known to those skilled in the art. The interface 66 provides two way communications between the message engine 56 and the clearing system 64. In addition, the matching engine 60 may optionally have a direct communication link 68 to the clearing system 64. In this direct connection embodiment, the matching engine 60 will only notify the clearing system 64 of trade transactions that are matched by the matching engine 60. In other embodiments, all communication from the matching engine 60 to and from the clearing system 64 will pass through the message engine 56.

In one aspect of an embodiment of the present invention, the message engine 56 validates the key information for trade transaction data that have been entered into the system 50, either directly or though a subsystem. For instance, the data identifying the parties must match party identifiers contained within the exchange databases. If key information is missing or entered using an invalid code, the message engine 56 will send the entering party an error message identifying the missing or incorrect data. Furthermore, the validation step verifies that the price data are valid for the particular financial instrument identified in the trade transaction data. This optional validation step only will make sure that the data are valid. Valid, but incorrect, data will still be processed. This incorrect data will possibly be corrected by one of the parties during the periods when the data, including key information, can be changed.

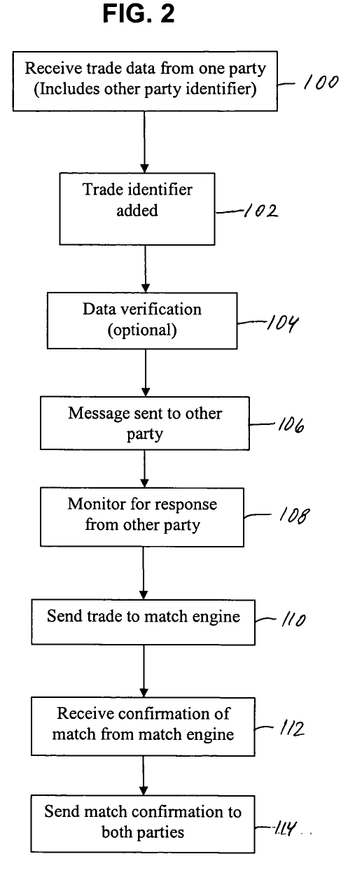

With reference to FIG. 2, in one embodiment the message engine 56 in a block 100 receives trade transaction data that an initiating party has entered into one of the various input devices, such as the handheld device 54. The trade transaction data that are received should include at least the key information described above. The trade transaction data also can include other non-key information, but for certain embodiments of the present invention the key information is the minimum information that must be present to fully identify the trade transaction to the message engine 56. For other embodiments, it may be possible to include less than all key information and still successfully match the trade transaction prior to clearing. Control now passes to a block 102 that then adds a trade identifier to the trade transaction data that have been received by the message engine 56. The trade identifier is a unique identifier of the trade transaction data so the trade transaction data can be tracked by the system 50 and the message engine 56.

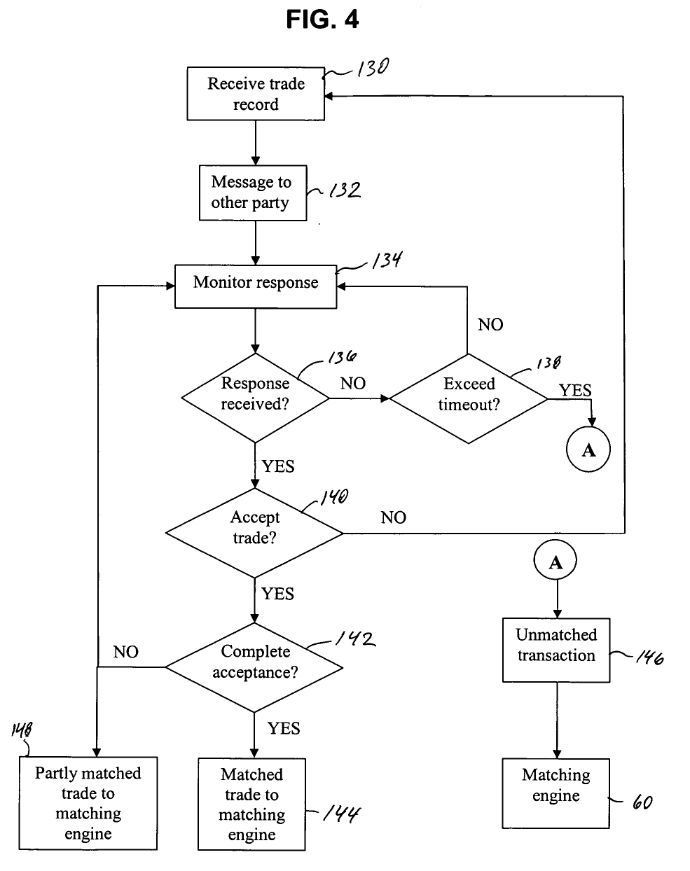

At this point, the message engine 56 passes control to a block 104 that performs the optional data validation step discussed above. The trade transaction data are verified to make sure that the key information within the trade transaction data are valid entries. In addition, the message engine 56 may confirm that all identified parties are capable of sending and receiving electronic trade transaction data. Other data verifications can also be conducted at this point. Control then passes to a block 106 that sends a message to the other or opposing party or parties to the trade as identified by the key information data received by the block 100. This message will usually include all the key information relative to the trade transaction and may include other information referred to above. Control passes to a block 108 that monitors a message queue for a response message relative to the trade transaction data sent by the other or opposing party. Details relating to the monitoring conducted by the block 108 are discussed below relative to FIG. 4.

In certain embodiments, this response message can be an acceptance of the trade transaction message generated by the block 106. In other embodiments, this response message also can be an independent recording of the trade transaction data by the other party. This can occur when parties on both sides of the trade transaction record the trade transaction data at roughly the same time. Based on the rules and business practices at certain exchanges, the system may be set up in certain embodiments to require that the seller always enter and record the trade transaction data. In this particular embodiment, the seller will not be able to accept trade transaction data that had been previously entered by the buyer. In other embodiments, the first person, either buyer or seller, to enter the trade transaction data becomes the initiating party and the other party can accept or link to the previously entered trade transaction data. Also, as discussed below, the acceptance of the trade transaction data can be automated, such that if there is a match to trade transaction data entered by the opposing party in that party's own input device, the device or computer can either suggest acceptance of a particular trade transaction or actually automatically link the incoming trade transaction data to previously entered trade transaction data in memory of the device without further interaction by the opposing party. The auto-linking feature is an option that the trader can set in that party's respective input device. Typically, the auto-linking feature will only automatically link trade transaction data that are a perfect match, that is, trade transaction data where all the key information is an exact match.

At this point, the message engine 56 in a block 110 sends the linked trade transaction data from the buyer and seller to the matching engine 60. In many instances, the trade transaction data sent to the matching engine 60 will be a linked trade transaction. However, the block 110 can also send unmatched trades to the matching engine 60. Control then passes to a block 112 that monitors communications received from the matching engine 60. If the matching engine 60 is able to match the trade transaction data, the matching engine will send a message confirming the match to the message engine 56. If the block 112 receives the match confirmation message from the matching engine 60, the control passes to a block 114 that sends a confirmation message to all of the parties to the trade transaction. Also, in certain embodiments, the message engine 56 will notify the clearing system 64 of the match. In other embodiments, the matching engine 60 will notify the clearing system 64 directly at the same time the match confirmation message is sent to the message engine 56.

As will be discussed more fully hereinafter, changes can be made to the key information prior to the trade transaction data being matched either by the matching engine 60 or by the clearing system 64. However, even after the trade transaction data are matched and the key information is locked, in some embodiments it is possible to enhance the trade transaction data with additional non-key information as is currently done by broker back office personnel. For instance, it is possible to add billing, and other similar information to the trade transaction data even after the trade transaction data have been matched. In addition, for some embodiments, the system 50 may allow a limited period of time after a trade transaction has been accepted or linked by the opposing party in the block 106 for either party to make changes to any data, including key information. If key information is changed, the message engine 56 will notify all parties to the trade transaction that key information has been changed and remove the trade transaction from the linked state. Typically, this limited period of time will be short, but long enough to allow a trader to realize that an acceptance of a trade transaction or other data have been entered incorrectly and easily rectify the error without requiring complicated mismatch procedures. For instance, where a party enters a valid but incorrect identifier for the opposing party and where that incorrect party inadvertently links to the trade transaction, either party for a short period of time can cancel the trade transaction or at least cancel the acceptance or link to the trade transaction. In addition, the initiating party can make a change to the opposing party identifier so that the proper opposing party is identified in the trade transaction data and that the proper opposing party can thereafter accept or link to the trade transaction. Because the exchange can monitor the intra-day activity, the exchange can audit these changes after linking to be sure that there is no abuse of the exchange rules and regulations.

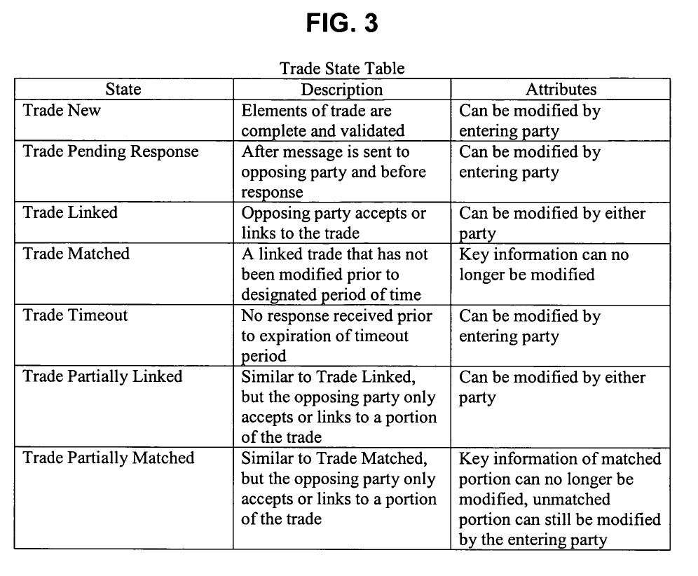

In one embodiment of the system 50, the trader can make modifications or corrections to trade transaction data that they have entered into the system 50 or trade transaction data that have been entered on their behalf into the system 50. However, the ability to make changes is dependent on the state of the trade transaction in the system 50. FIG. 3 shows a state table showing the states that a trade transaction may pass through as the trade transaction proceeds through the system 50. In one embodiment, the trade transaction can be made up of one or more TREX transactions. When new trade transaction data are recorded by the appropriate input device, the state of the trade transaction data is Trade New. When the trade transaction data in the Trade New state are communicated to the message engine 56, the trade transaction data state will change from the Trade New state to a Trade Pending Response state. During the time that the trade transaction data are in either of the Trade New state or the Trade Pending Response state, the entering party can go into the trade transaction data and make changes to any field in the trade transaction data, including key information. This enables an entering party to correct errors made while entering the trade transaction into the particular computer device. While the trade transaction data are in either of these states, the trade transaction data can also be completely deleted. Once the opposing party has accepted or has linked to the trade transaction data, the trade transaction data move to the Trade Linked state. During the time that the trade transaction data are in the Trade Linked state, either party to the trade transaction can make changes to any of the data fields of the side of the trade transaction that party entered, including key information fields. If a change is made to a key information field, the state of the trade transaction is changed from the Trade Linked state to the Trade Pending Response state and the message engine 56 sends a message to the other party breaking the link. The former opposing side of the trade transaction is now in a Trade Pending Response state.

A particular trade transaction will remain in the Trade Linked state for only a limited predetermined period of time. Once this time period has elapsed without any changes made to the trade transaction data, the state then changes to a Trade Matched state. In the Trade Matched state, the trade transaction data are fixed and the key information can no longer be either modified or deleted by either party. However, non-key information can still be modified or enhanced as is currently done by many exchanges and clearing systems.

In the event that the trade transaction data are partially linked, the trade transaction data will go to the Trade Partially Linked state. In this state, the portion of the trade transaction data that have been linked are treated in the same fashion as the Trade Linked state above. In addition, the unlinked portion of the trade transaction data can still be changed or deleted. After the appropriate period of time has elapsed, the trade transaction data will move to the Trade Partly Matched state. The portion of the trade transaction data that have been matched are treated as a matched trade transaction so that the key information of that portion of the trade transaction data can no longer be changed or modified. The unmatched portion of the trade transaction is treated as if it is an unmatched trade transaction. This portion can be changed or even deleted. The remaining state, the Trade Timeout, allows the entering party to make modifications to the transaction or to delete the transaction entirely. It will be appreciated that because one objective of the system and method of the present invention is intra-trading day confirmation certainty, it should not be possible to delete or change key information for a matched trade transaction unless it has been determined that the match was made in error and both parties agree to an unmatch process. Non-key information, i.e., information that is not core to the nature of the trade transaction between the parties, can be modified, added or enhanced as can now be done in conventional systems. However, in the embodiment that uses the Trade Linked state, there will be a limited period of time after a trade transaction has been accepted or linked for any party to the trade transaction to correct errors, including errors in key information fields.

FIG. 4 shows the steps that the message engine 56 takes as the message engine 56 receives trade transaction data. A block 130 receives trade transaction data entered by one party to the trade transaction. As noted previously, the trade transaction data can be entered into the system 50 using any of the appropriate input devices. If the trade transaction data received by the block 130 include information relative to the identity of the opposing party, a block 132 sends a message to the computer of the opposing party. In certain embodiments, traders may be able to use multiple input devices to send and receive trade transaction data and other information. These devices can be separate order/trade entry computers 52 and/or handheld devices 54 that are each used to make trades and to receive information relative to a particular product. Alternatively, the trader can use the order/trade entry computer 52 and also use the handheld device 54. Each input device will be registered by the system 50 so that the message engine 56 knows which device to send the appropriate messages. For instance, a broker may be trading in multiple agricultural pits at the same time and may have one handheld device 54 for trade transactions that relate to corn and another handheld device 54 that relates to trade transactions for soybeans. It is possible that the devices could be specified to receive trade transactions that relate only to a particular contract, such as September 2005 corn. Further, a single handheld device 54 can be programmed to accept messages and enter and send data relative to multiple instruments. The message engine 56 can be programmed to recognize the appropriate device for the broker based on the identity of the broker or trader and the product being traded.

At this point, control passes to a block 134 that monitors for a response from the opposing party. It should be noted that in certain embodiments, the message engine 56 can be programmed to allow a surrogate or proxy that has been predesignated by a trader to accept trade transactions on behalf of that trader. This monitoring is done by a loop that passes through a block 136 that checks to see if a response has been received from the opposing party identified in the trade transaction data. If no response has been received, control will pass via the NO branch to a block 138 that checks to determine if the elapsed time since the trade transaction data were recorded has exceeded a preset timeout period. In some embodiments, the timeout period may be set to a relatively short period of time, such as 30 minutes. This period will provide the opposing party sufficient time to catch up if there has been a high level of activity and accept, link to or enter trade transaction data for trade transactions that have been made. A short timeout period will also encourage traders and brokers to promptly enter trade transaction data in a timely fashion so that there are a minimum number of trade transactions where the trade transaction data do not match. Also, by entering data quickly, the trade transaction can be confirmed in near real time so that the trader knows that the trade transaction has been confirmed and the risk of an out trade has been minimized, at least for that trade transaction. If the timeout period has not been exceeded, control will pass back to the block 134 that begins the monitoring loop anew. If the block 136 determines that a response has been received relative to the trade transaction data received in the block 130, control will pass via the YES branch to a block 140 that determines the nature of the response. If the response is an acceptance of the trade transaction, the block will branch via the YES branch to a block 142 that determines the nature of the acceptance. If the block 142 determines that the acceptance is a complete acceptance of the trade transaction data recorded in the block 130, control passes to a block 144 that sends the trade transaction data on to the matching engine 60 as a linked pair to be matched based on an intra-day matching algorithm to be more fully discussed hereinafter. Alternatively, the message engine 56 can perform limited matching for perfect matches that have been accepted by the other party and these matched trade transactions can be sent directly by the message engine 56 to the clearing system 64.

If the block 138 determines that the timeout period has been exceeded, control will pass via the YES branch to a block 146 that identifies the trade transaction as an unmatched trade transaction and sends the unmatched trade transaction to the matching engine 60. At some point during the day, the trade transaction data that remain as unmatched in the matching engine 60 will be forwarded on to the clearing system 64 for conventional end-of-day matching and balancing. If the block 140 determines that the response received is a rejection of the trade transaction, control will pass from the block 140 via the NO branch to the block 130. At this point the block 132 sends a message to the initiator indicating that the trade transaction was rejected. The trade transaction will go back to the block 134 that monitors for a further response. If no response is received during a new timeout period the block 138 will branch via the YES branch and the trade transaction will be marked by the block 146 as an unmatched trade transaction. Thereafter, the trade transaction data are sent on to the matching engine 60. In certain embodiments, if the rejected trade transaction data are not matched during the day, the rejected and still unmatched trade transaction data will also be forwarded on to the clearing system 64 for conventional end-of-day processing and matching. In other embodiments, the unmatched trade transaction data will be sent to clearing 64 prior to the end of the day.

If the block 142 determines that the acceptance is a partial acceptance of the trade transaction, control will pass via the NO branch to both the block 134 to continue to monitor for a response to the unaccepted portion of the trade transaction, and to a block 148 that sends the portion of the trade transaction that has been matched and accepted to the matching engine 60 as a linked pair of trade transaction data. For example, the trade transaction received in the block 130 has multiple opposing parties that each take a portion of the contracts the seller has to sell. Assume that the seller sells 20 contacts of September 2005 corn and Buyer A buys 7 contacts and Buyer B buys 13 contacts. When Buyer A accepts the 7 contract trade transaction, that partial trade transaction will be sent to the matching engine 60 as a linked pair. If Buyer B later accepts the 13 contacts, then those 13 contacts will be ultimately sent on to the matching engine 60 as a linked pair. However, if Buyer B does not respond within the timeout period or at all, the 13 contacts sold to Buyer B will be considered as an unmatched trade transaction and will be sent to the matching engine 60 for a possible later intra-day match and ultimately on to the clearing system 64 for conventional end-of-day processing. In a situation where the initiator enters an incorrect number of contracts or instruments, the other party can accept the number they believe to be accurate and reject the remainder. The rejected remainder will be considered as unmatched and the seller will be so notified. An example of this partial acceptance is the situation where initiator incorrectly enters 50 contracts, but the opposing party was only buying 15 contracts. In this situation, the opposing party will only accept the 15 contract portion of the trade transaction and the remaining 35 contract portion of the trade transaction ultimately will be sent to the clearing system 64 as an unmatched trade transaction. The initiator will be sent a message by the message engine 56 that only a portion of the trade transaction was accepted and linked.

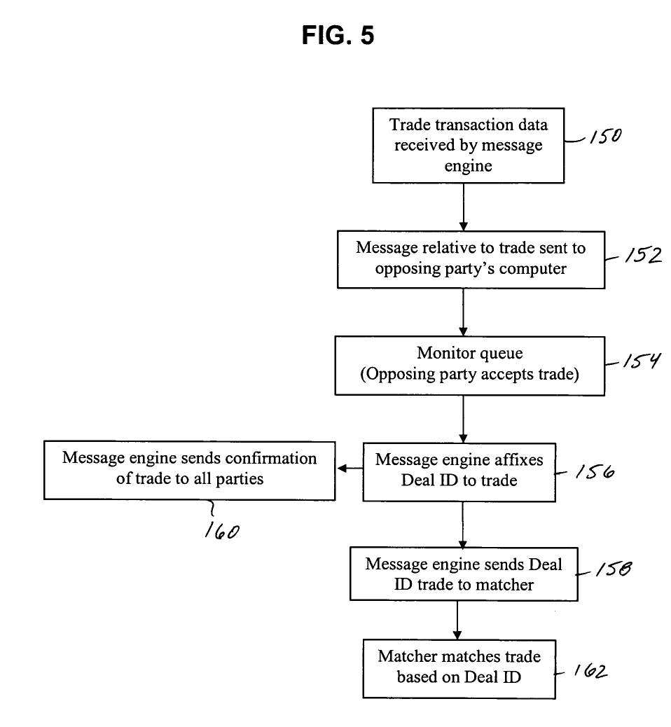

FIGS. 5 to 10 show examples of certain aspects of the message engine 56, including examples of opposing parties linking to trade transaction data, an example of a change to trade transaction data while in the link state and an example showing a match where there is no actual acceptance or linking.

FIG. 5 shows a block diagram of one embodiment of the message system and method of the present invention. A block 150 receives trade transaction data that an initiating party, such as a seller, has entered into an input device, such as the handheld device 54. Typically, an exchange will affix a Record ID to the trade transaction data received by the block 150. In addition, for certain embodiments, the message engine 56 can affix the Record ID to the trade transaction data as the trade transaction data are received by the message engine 56. This Record ID is used to track the particular trade transaction data that have been entered by the initiating party. At this point, a block 152 sends a message to the opposing party's computer, which can be any of the various input devices noted in FIG. 1. The opposing party receives the message and the opposing party's input device will highlight the message received from the message engine 56 and ask the opposing party to accept or reject the trade transaction data. In this case, the opposing party accepts the trade transaction. A block 154 in the message engine 56 monitors a message queue for messages relative to the trade transaction data, and receives the acceptance of the trade transaction from the opposing party. Control will then pass to a block 156 that affixes a Deal ID to the trade transaction data and links the trade transaction. Following a predetermined link period, and if the trade transaction has not been modified by either party, a block 158 in the message engine 56 sends the trade transaction data including the Deal ID and the identity of both the seller and the buyer to the matching engine 60. At the same time, the block 156 also passes control to a block 160 that sends a confirmation message to all parties to the trade transaction that the trade has been linked. This confirmation message can be sent before the trade transaction data have been matched by the matching engine 60 for perfect matches, or can be sent after the matching engine 60 sends the message engine 56 the match confirmation message. Control then passes from the block 158 to a block 162 in the matching engine 60 that matches the trade transaction data based on the Deal ID. All parties now are confident that the trade transaction has been properly recorded by the exchange and this trade transaction has been properly matched. As noted above, in certain embodiments the matching engine 60 will also send a confirmation message to the message engine 56 that the trade transaction data have actually been matched, and the message engine 56 will then send a confirmation message to all parties to the trade transaction. A particular trader's input device, such as the handheld device 54, will have access to the intra-day matching data and the trader will know those trade transactions that have been made that day, including trade transactions that have been matched, and trade transactions that remain in an unmatched state. At this point, the matching engine 60 will pass the matched trade transaction data directly to the clearing system 64 for end-of-day processing or send a message to the message engine 56 to instruct the message engine 56 to send the matched trade transaction to clearing 64.

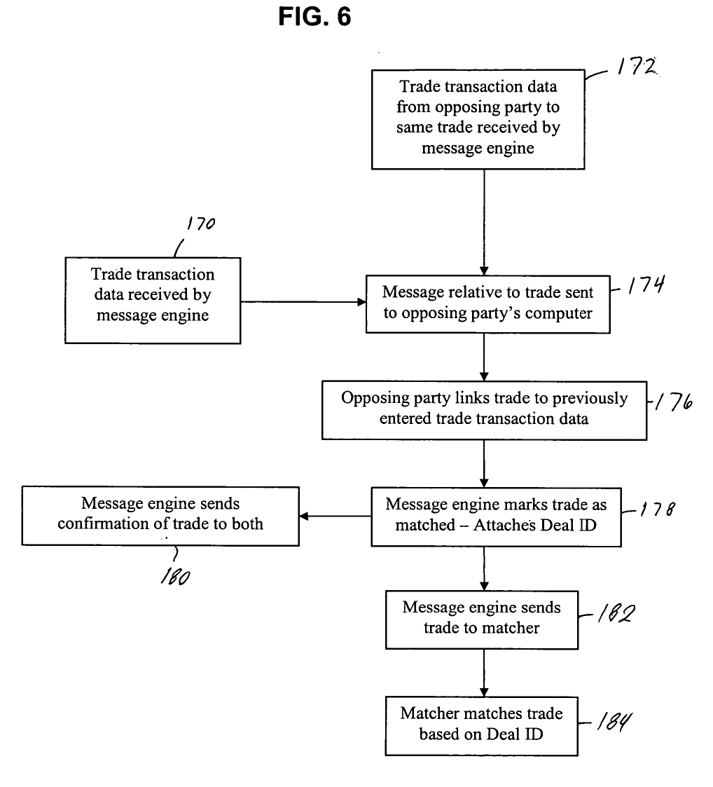

FIG. 6 shows another embodiment of the present invention. A block 170 in the message engine 56 receives trade transaction data that an initiator, either a buyer or a seller, has entered into that party's computer input device. Prior to receipt by the block 170, a Record ID has been affixed to the trade transaction data. At roughly the same time as the initiator has entered the trade transaction data into the initiator's computer, an opposing party also records the trade, which is received by the message engine 56 in a block 172. The message engine 56 passes control to a block 174 that sends an advisory message to the opposing party's computer relative to the trade transaction data received by the block 170. The advisory message includes a block 176 that allows the opposing party to link the trade transaction data received by the block 170 to the trade transaction data that the block 172 has received based on the input from the opposing party. As noted previously, in an alternative embodiment, a trader may program the trader's computer or input device to automatically link trade transaction data that are a perfect match, i.e., one where the key information of trade transaction data exactly match to trade transaction data that previously have been entered on that trader's computer. After the link has been made, control then passes to a block 178 in the message engine 56 that marks the trade transaction data received by the block 170 as linked. In addition, the message engine 56 also affixes a Deal ID to the linked transactions. After the trade transaction data have been marked as linked by the block 178, control then passes to a block 180 that sends a confirming message that the trade transaction has been linked to both the buyer and the seller and to a block 182 that sends the linked trade transaction data to the matching engine 60. At this point, the matching engine 60 in a block 184 matches the trade transaction data based on Deal ID.

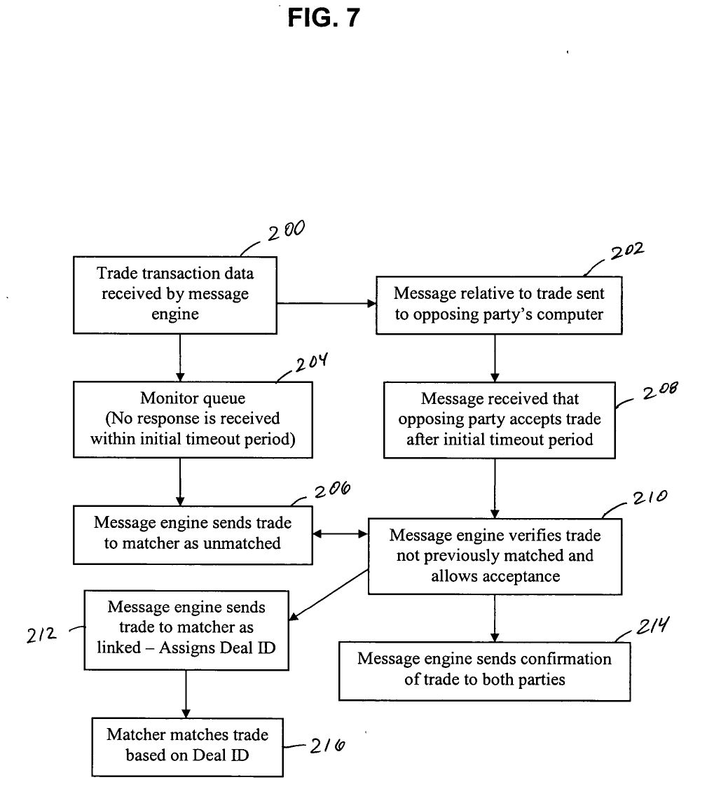

FIG. 7 shows another embodiment of the present invention that allows a party to accept a trade transaction even after the initial timeout period has expired. In this embodiment, care must be taken to avoid a race condition, i.e., a situation where two different systems compete to simultaneously match the trade transaction. Depending on the time taken after the initial timeout period has expired, it may be possible that the trade transactions will have been previously sent on to the clearing system 64 and that the clearing system 64 will be attempting to match the trade transactions. In certain embodiments, a party will only be able to link to a trade transaction that has passed beyond the initial timeout period, where the period beyond the initial timeout period is less than a predetermined second timeout period. In this case, the message engine 56 at a block 200 receives the trade transaction data that have been entered relative to a trade transaction concluded by an initiating party. These trade transaction data include a Record ID to identify the transaction data. The message engine 56 passes control to a block 202 that sends a message to an opposing party identified by the initiator as the other party to the trade transaction. The message engine 56 will monitor the message queue in a block 204 for a response to the message sent by the block 202. In this instance, the opposing party does not accept the trade transaction within the prescribed initial timeout period. When the initial timeout period elapses without receiving a responsive message, the block 204 determines that the initial timeout period has expired for that trade transaction. At this point, control will pass to a block 206 that sends the trade transaction data to the matching engine 60 as an unmatched trade transaction.

Sometime after the expiration of the initial timeout period, but before the expiration of the second timeout period as discussed above, a block 208 receives a message that the opposing party accepted the previously notified trade transaction using the opposing party's input device. Control will then pass to a block 210 that queries the message engine 56 to determine the current state of the trade transaction data the buyer has accepted. Because the trade transaction has initially timed out, the block 210 determines that the trade transaction is still in the Trade Unmatched state and the block 210 accepts the link from the opposing party to the trade transaction data entered by the initiator. Control will then pass to a block 212 that changes the state of the previously unmatched trade transaction data to Trade Linked, affixes a Deal ID to the linked trade transaction data, and sends the linked trade transaction data to the matching engine 60. Control also passes to a block 214 that sends a confirmation of the newly matched trade transaction to both the buyer and the seller. The block 212 also will pass control to a block 216 that matches the trade transaction data based on Deal ID and changes the state of the trade transaction to Trade Linked and then after a suitable period of time to Trade Matched. At this point, the trade transaction data are sent to the clearing system 64. Because trade transaction data will be sent to the clearing system 64 throughout the day, the matching engine 60 may also need to check with the clearing system 64 before a match is made with trade transaction data that has been previously sent to the clearing system 64 to be sure that the clearing system 64 has not already matched the trade transaction data with other trade transaction data.

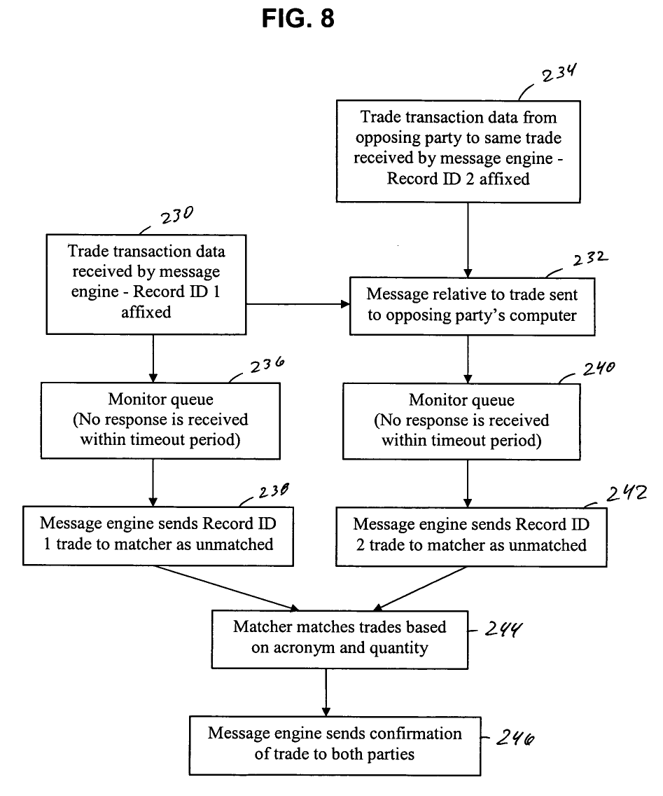

In FIG. 8 an additional embodiment of the invention is shown. A block 230 receives the trade transaction data information that has been entered by an initiator with a first Record ID affixed to the trade transaction data. The message engine 56 then passes control to a block 232 that sends a message to the designated computer of the opposing party identified by the initiator in the trade transaction data. Previously, a block 234 had received the opposing party's entry of trade transaction data relative to the same trade transaction. However, the opposing party did not respond to the message that was generated by the block 232. A block 236 monitors the responses from various users and records that no response was received from the opposing party prior to the expiration of the timeout period. The message engine 56 passes control to a block 238 that sends the initiator's trade transaction data to the matching engine 60 as an unmatched trade. The message engine 56 at a block 240 also monitors the message queue relative to the trade transaction data received by the block 234. After the expiration of the initial timeout period, the message engine 56 at a block 242 sends the opposing party's trade transaction data to the matching engine 60 as an unconfirmed trade transaction with a second Record ID attached to the opposing party's trade transaction data.

After both the seller's trade transaction data and the buyer's trade transaction data are received by the matching engine 60 from blocks 238 and 242, a block 244 attempts to match the above referenced trade transaction data based on various criteria in the matching algorithm of the matching engine 60. In one embodiment of a matching algorithm, the first step in the matching algorithm is to group trade transactions in a hierarchical manner. The hierarchy is contract type, i.e., outright trades, spread trades, and SLEDS trades; then product, i.e., agricultural: corn; then contract type, i.e., futures or options; next for options is the type, i.e., put or call; then the contract date; and lastly the strike price. Using this approach, all outright trades for corn put options for December 2005 at 110 will be grouped for searching and matching. The second step is the actual matching algorithm. Initially the algorithm looks for perfect matches, that is, those trade transaction data where all the key information in two opposing trade transactions match exactly. The first pass in the matching algorithm is a match based on Deal ID. This is the case where the one party accepts a trade transaction initially entered by the opposing party. Here both sides to the trade transaction will have trade transaction data that have a matching Deal ID. The second pass in the algorithm is a match based on firm, acronym, time bracket, and quantity. The third pass is similar to pass two but for block trades. The fourth pass uses a secondary identity of the trading party, sometimes identified as MCR or modified contra reporting, acronym, time bracket and quantity. The fifth pass is similar to the fourth pass but for block trades, and the sixth pass performs a partial trade quantity match to link components of a larger trade transaction on one side to smaller individual trade transactions on the other side. If no match can be made, in certain embodiments, the trade transaction will be held for later matching and if unmatched at the end of the day or after a predetermined period of time, the trade transaction data will be forwarded on to the clearing system 64 for matching using the matching algorithms of the clearing system 64. In addition, other suitable matching algorithms or matching schemes can be used.

If the matching engine 60 finds a match based on the intra-day matching algorithm, control will pass back to the message engine 56 and a block 246 sends a confirmation message to both parties that the trade transaction has been matched. Because both parties had entered the trade transaction data, even though neither party acknowledged the trade transaction, the matching engine 60 is able to make an intra-day match and alert both parties that the trade transaction has been confirmed.

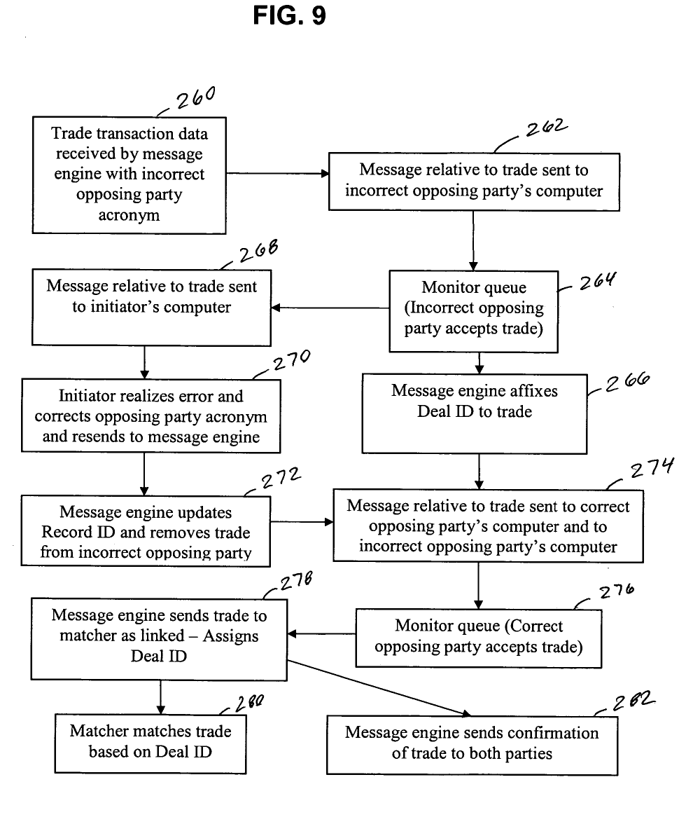

FIG. 9 shows the flexibility of one embodiment of the present invention that enables traders to easily correct an error in data entry provided that the error is corrected quickly enough. A block 260 receives the trade transaction data that an initiator has entered into the initiator's input device, such as the handheld device 54. The data that have been entered by the initiator include an incorrect identification of an opposing party. A Record ID has also been affixed to the trade transaction data. The message engine 56 in a block 262 sends a message to the incorrectly identified opposing party and the message engine 56 monitors the message queue in a block 264 and receives an acceptance message from the incorrectly identified opposing party, who mistakenly accepts the trade transaction data. As discussed previously, the message engine 56 in a block 266 affixes a Deal ID to the linked trade transaction data and also at the same time, a block 268 sends a message to the initiator. At this point the state of the trade transaction is Trade Linked. This means that either party can change any of the data of the trade transaction data so long as the trade transaction data remain in the Trade Linked state. In a block 270, the initiator realizes an error in identification has been made and makes a change to the key information relating to the identity of the opposing party. In a similar manner, the opposing party could also recognize that the acceptance of the trade transaction in the block 264 was in error and the opposing party could also cancel the opposing party's acceptance of the trade transaction data. The corrected trade transaction data are sent to the message engine 56 and the message engine 56 in a block 272 updates the data relative to the Record ID and removes the trade transaction from the Trade Linked state and also removes the trade transaction data from the incorrect opposing party. Control passes to a block 274 that sends a message to the correct opposing party allowing the correct opposing party to link to the trade transaction data. In addition, the block 274 sends a message to the incorrect opposing party indicating that the trade transaction has been canceled. Similar to FIG. 5, the correct opposing party accepts the trade transaction that is received in a block 276 by the message engine 56 monitoring the message queue. In a block 278, the message engine 56 assigns a new Deal ID, sends the linked trade transaction data to the matching engine 60 as linked trade transaction data. In a block 280, the matching engine 60 matches the trade transaction data based on the Deal ID. At roughly the same time, the message engine 56 in a block 282 sends a confirmation of the trade transaction to both parties.

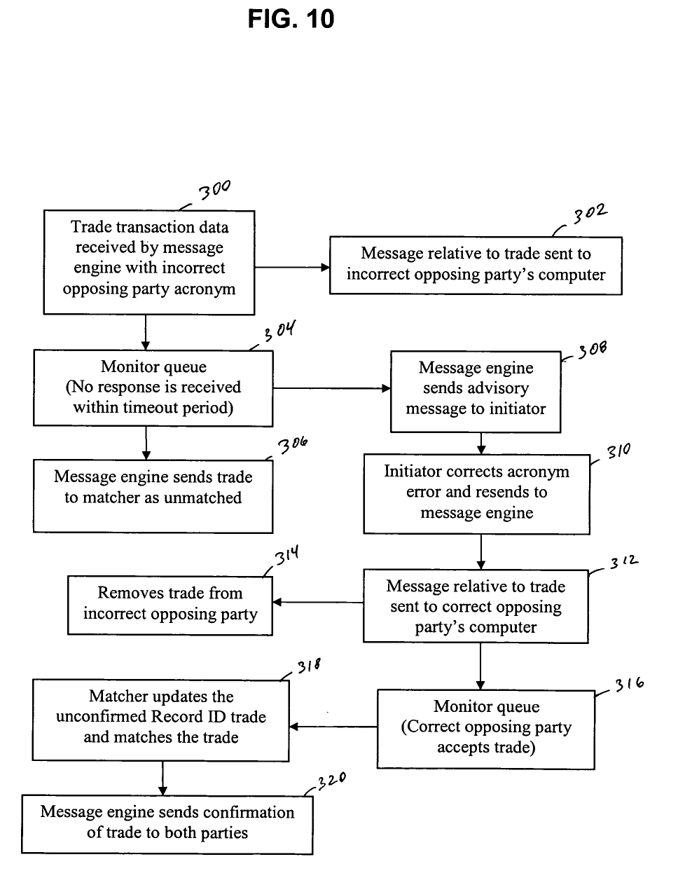

As shown in FIG. 10, an additional embodiment demonstrates a further way that errors made during entry can be corrected, in this case prior to a match or a link. An initiator enters trade transaction data that include an incorrect identification of the opposing trader. One identification system typically used by exchanges assigns each trader and firm a unique acronym. At some exchanges, the acronyms comprise a few letters, while at other exchanges the acronyms can be numbers or a combination of letters and numbers. Many input devices, such as the handheld device 54 can store frequently used acronyms of traders and brokers that are commonly encountered during a trading day. It may be possible that a trader will choose a wrong acronym to identify the opposing trader. A block 300 receives the trade transaction data that also happen to include an incorrect identification of the opposing trader. A Record ID is affixed to the trade transaction data. The message engine 56 passes control to a block 302 that sends a message to the computer of the incorrectly identified opposing party. In this case, the opposing party ignores the message and does nothing. The message engine 56 will monitor the message queue in a block 304. Because no response is received within the initial timeout period, the message engine 56 will pass control to a block 306 that sends the

At this point, the embodiment will operate as before. If the correct opposing party accepts the trade transaction, a block 316 that monitors the message queue will receive the acceptance message and pass control to a block 318 that sends the trade transaction data to the matching engine 60, and matches the trade transaction data. The message engine 56 also will assign a Deal ID to the linked trade transaction data. Control passes back to the message engine 56 and a block 320 sends the confirming message out to both correct parties. In the event that the opposing party does not accept within the timeout period but has previously entered correct trade transaction data for the trade transaction, the trade transaction will still be matched as in FIG. 8 based on the intra-day matching algorithm.

If the incorrect opposing party accepts the incorrect trade transaction and if the trade transaction moves from the Trade Linked to the Trade Matched state, then the trade transaction will be considered as matched and neither party will be able to unilaterally change the trade transaction. In this case, the buyer and seller must agree to unmatch the trade transaction outside the system described here. After the trade transaction has been manually removed from the matched state, one party must reenter the trade transaction and indicate that this is a mismatched trade. By doing so, the trade will be properly accounted for in all the volume and other statistics that are maintained and published by exchanges. Once this has been done, the trade transaction can be matched or accepted in the normal course.

The embodiments of the present invention have been described primarily with respect to financial instruments traded on a single exchange. It is possible that the present invention can also be used to confirm trades on different exchanges or trade or financial instruments in different asset classes traded on a single exchange, such as a spread that includes a futures contract and an option. As exchanges continue to cooperate in the trading of financial instruments, it may be possible for traders to trade a single financial instrument that represents multiple financial instruments that are individually traded on separate exchanges in a face to face or similar non-anonymous environment.

### INDUSTRIAL APPLICABILITY

This invention is useful in assisting trade exchanges and/or exchange users to save cost, increase speed and trade transaction processing, and manage risk. unconfirmed trade transaction data to the matching engine 60 with a Record ID and also to a block 308 that sends an advisory message to the initiator that the trade transaction has not yet been confirmed. At this point, the initiator realizes that an error has been made. Because the trade transaction is unmatched, the state of the trade transaction will be Trade New. This particular state allows either party to make modifications to all aspects of the trade transaction data, including key information, and therefore the initiator is able to correct the trade transaction data to reflect the correct identification of the opposing party. The trader records the changes in the trade transaction data and forwards the corrected trade transaction data to the message engine 56 where the corrected trade transaction data are received by a block 310. If the incorrectly identified opposing trader rejected the trade instead of ignoring the message, the message engine 56 will send a message to the initiating party that the trade has been rejected. Just as above, the initiating party can correct the identity of the opposing party and resubmit the trade transaction. This resubmission can be done either before or after the initial timeout period has expired.

The message engine 56 recognizes that the trade transaction data relate to a trade transaction that has a previously affixed Record ID and message engine 56 passes control to a block 312 that sends a message to the correct buyer. At the same time, the message engine 56 also passes control to a block 314 that removes the incorrect opposing party from the trade transaction data associated with the Record ID and also removes the trade transaction from the incorrect opposing party's computer. The trade transaction data with the incorrectly identified opposing party will also be removed from the matching engine 60. This step will make it less likely that the incorrect opposing party will attempt to link to the incorrect trade transaction data. The system 50 will also correctly identify and deal with a situation where the initiator even before the timeout period has elapsed realizes the error and makes the correction to the opposing party identification. In this case, the message engine 56 will immediately send a message on to the correct opposing party and also remove the trade transaction from the incorrect opposing party's computer lessening the opportunity for an incorrect acceptance of the trade transaction.

Numerous modifications to the present invention will be apparent to those skilled in the art in view of the foregoing description. Accordingly, this description is to be construed as illustrative only and is presented for the purpose of enabling those skilled in the art to make and use the invention and to teach the best mode of carrying out same. The exclusive rights to all modifications which come within the scope of the appended claims are reserved.

We claim:

1. A message service to facilitate the early confirmation of a trade transaction in a non-anonymous trading environment comprising:
a message reception circuit that receives a message from one party to the trade transaction, the message including trade transaction data that includes an identity of an opposing party to the trade transaction;
an outgoing message circuit that sends a message to the opposing party that includes data identifying the trade transaction; and
a monitoring circuit that monitors a message queue for a message from the opposing party and
a) if an acceptance message is received from the opposing party, sends a confirming message to the one party and sends the trade transaction to a matching engine as a pre-matched trade;
b) if no response is received from the opposing party within a predetermined period of time, sends an alert message to the one party and sends the trade transaction to the matching engine as an unmatched trade; or
c) if a rejection message is received from the opposing party, sends an alert message to the one party.

2. The message service of claim 1 wherein the monitoring circuit d) if a partial acceptance message is received from the opposing party, sends a message to the one party that confirms the partial acceptance and sends the partly accepted trade to the matching engine as a pre-matched trade and, in addition, continues to monitor the message queue for a message from the opposing party relative to the portion of the trade transaction that is not accepted.

3. The message service of claim 1 that includes an authorization circuit that determines if the one party and the opposing party are each authorized to receive electronic transactions.

4. The message service of claim 3 wherein the authorization circuit also determines the identity of the device to receive messages for a particular trade transaction.

5. The message service of claim 1 that includes a match circuit that receives a message from the matching engine that the trade transaction has been matched and forwards this message on to the one party and the opposing party.

6. The message service of claim 1 wherein the data relating to the trade transaction includes a unique identifier for that trade transaction.

7. The message service of claim 1 wherein the trade transaction is a multi leg transaction.

8. The message service of claim 1 wherein the trade transaction is a single leg transaction.

9. The message service of claim 1 wherein the acceptance message is in the form of independently entered trade transaction data that matches the trade transaction data entered by the one party.

10. The message service of claim 1 that includes a data verification circuit to verify one element of the data.

11. A method of facilitating the early confirmation of a trade transaction in a non-anonymous trading environment, the method comprising the steps of:
receiving a message from one party to the trade transaction, the message including data relating to the trade transaction including an identity of an opposing party to the trade transaction;
sending a message to the opposing party that includes data identifying the trade transaction; and
monitoring a message queue for a message from the opposing party and
a) if an acceptance message is received from the opposing party, sending a confirming message to the one party and sending the trade transaction to clearing as a pre-matched trade;
b) if no response is received from the opposing party within a predetermined period of time, sending an alert message to the one party and sending the trade transaction to clearing as an unmatched trade; or
c) if a rejection message is received from the opposing party, sending an alert message to the one party.

12. The method of claim 11 wherein the monitoring step d) if a partial acceptance message is received from the opposing party, sending a message to the one party that confirms the partial acceptance and sending the partly accepted trade to the matching engine as a pre-matched trade and, in addition, continuing to monitor the message queue for a message from the opposing party relative to the portion of the trade transaction that is not accepted.

13. The method of claim 11 including the step of determining if the one party and the opposing party are each authorized to receive electronic transactions.

14. The method of claim 13 including the step of determining the identity of the device to receive messages for a particular trade transaction.

15. The method of claim 11 including the step of receiving a message from the matching engine that the trade transaction has been matched and forwarding this message on to the one party and the opposing party.

16. The method of claim 11 wherein the data relating to the trade transaction includes a unique identifier for that trade transaction.

17. The method of claim 11 wherein the trade transaction is a multi leg transaction.

18. The method of claim 11 wherein the trade transaction is a single leg transaction.

19. The method of claim 11 wherein the acceptance message is in the form of independently entered trade transaction data that matches the trade transaction data entered by the one party.

20. The method of claim 11 including the step of verifying one element of the data.
